(19) United States
(12) Patent Application Publication
(10) Pub. No.: US 2010/0028217 A1
(43) Pub. Date: Feb. 4, 2010

(54) AIR DECONTAMINATION SYSTEM

(76) Inventor: Richard Haché, Montreal (CA)

Correspondence Address: BROUILLETTE & PARTNERS, METCALFE TOWER, 1550 METCALFE STREET, SUITE 800, MONTREAL, QC, H3A-1X6, CA

(21) Appl. No.: 12/524,888

(22) PCT Filed: Feb. 5, 2008
(86) PCT No.: PCT/CA08/00215

§ 371 Date: Jul. 29, 2009

Related U.S. Application Data
(60) Provisional application No. 60/898,702, filed on Feb. 1, 2007.

(51) Int. Cl. A62B 7/08

(52) U.S. Cl. 422/120

(57) ABSTRACT

The present invention generally relates to a system for the decontamination of air wherein airborne particles and other pollutants are either neutralized and/or destroyed by ozone. The system generally comprises an access chamber for receiving the air to be decontaminated, an ozone generator generally fluidly connected to the access chamber, and at least one treatment chamber, in communication with the access chamber, in which ozone, present in high concentration, can effectively neutralize and/or destroy the airborne particles and/or the other pollutants contained in the air. The air decontamination system is typically used in cooperation with the ventilation system of a building.

### CROSS-REFERENCE TO RELATED APPLICATIONS

The present patent application claims the benefits of priority of commonly assigned U.S. Provisional Patent Application No. 60/898,702, entitled “Device for Decontaminating Ventilation Ducts Using Ozone” and filed at the United States Patent and Trademark Office on Feb. 6, 2007.

### FIELD OF THE INVENTION

The present invention generally relates to the field of systems for the filtration, purification and/or decontamination of air. More particularly, the present invention relates to the field of systems for the filtration, purification and/or decontamination of air wherein ozone is the main decontamination agent.

### BACKGROUND OF THE INVENTION

In the last several years, scientists have found that the air inside homes and inside certain buildings can be more polluted than the air of certain of the world's biggest cities. Worldwide, roughly 30% of new buildings may suffer from serious indoor air problems.

Moreover, human lungs can treat up to 30 cubic meters of air each day. Hence, their prolonged exposure to small doses of harmful chemicals and/or airborne particles can cause several types of breathing troubles such as asthma and allergies. In addition, airborne viruses and bacteria present in the air can be responsible for illnesses such as influenza and pneumonia.

In order to clean, purify and/or decontaminate air, several systems and devices have been proposed and used throughout the years. These systems can generally be classified into two categories.

On the one hand, systems for the purification of air such as air filters are well known in the art and are commonly used to remove contaminants, often particulate in nature, such as dust and pollen. These filters are generally adapted to block and retain airborne particles having at least a certain predetermined minimal size. Hence, the efficiency of these filters is generally limited by the size of the particles they can block. Moreover, filters are generally of limited efficiency against chemical and organic contaminants and against microscopic contaminants such as bacteria, viruses and mildew.

Certain filters, such as HEPA filters, are adapted to retain finer particles and pollutants such as bacteria and mildew. Still, these special filters are usually more expensive and must be frequently replaced in order to maintain an adequate level of filtration. These frequent replacements of the filters generally imply considerable costs.

On the other hand, in order to mitigate the shortcomings of air filters, ozone-based air purification systems have also been proposed. Generally, these systems purify ambient air by diffusing and mixing ozone therewith, ozone generated from the oxygen present in the air or supplied for this purpose. Having strong oxidative properties, ozone neutralizes and/or destroys airborne contaminants such as harmful chemical substances, organic contaminants, particles, dusts, bacteria, viruses and mildews. By neutralizing and/or destroying airborne contaminants, the ozone effectively disinfects and purifies the air. An example of such a system is shown and described in U.S. Pat. No. 5,501,844.

Air purification systems using ozone have several advantages over air filters. For example, in those instances where ozone is generally directly generated from the oxygen present in the ambient air, there is no tank that needs to be filled or replaced. Additionally, since the ozone generators of these systems are usually electrically powered, these ozone-based air purification systems can generally be selectively turned on or off whereas air filters are mounted permanently.

Still, one of the main problems with current ozone-based air purification systems is that they inject ozone directly into the room where the ambient air needs to be decontaminated. Even though these systems are relatively effective against contaminants, since ozone is an irritant substance, its presence in ambient air, even in small concentration, can be uncomfortable and even harmful to higher life forms such as humans and animals.

There is therefore a need for a novel air purification and decontamination system advantageously using the oxidative properties of ozone for decontaminating air while minimizing the negative effects of ozone on humans and animals.

### OBJECTS OF THE INVENTION

Accordingly, one of the main objects of the present invention is to provide an air decontamination system which can remove, or at least reduce, the quantity of airborne particles, dust, bacteria, viruses, mildews and/or organic and chemical contaminants present in ambient air of a building using ozone as decontamination agent.

Another object of the present invention is to provide an air decontamination system which is adapted to treat a portion of ambient air with high concentrations of ozone to effectively neutralize and/or destroy most of the airborne contaminants contained therein but which is also adapted to mix the residual ozone with the untreated ambient air to keep the concentration of ozone in the air that is breathed by humans or animals at an harmless level for higher life forms.

Yet another object of the present invention is to provide an air decontamination system which can be used in cooperation with the ventilation system of a building.

Still another object of the present invention is to provide an air decontamination system which is preferably programmable and/or controllable.

Other and further objects and advantages of the present invention will be obvious upon an understanding of the illustrative embodiments about to be described or will be indicated in the appended claims, and various advantages not referred to herein will occur to one skilled in the art upon employment of the invention in practice.

### SUMMARY OF THE INVENTION

The present invention generally relates to an air decontamination system which can decontaminate the ambient air circulating inside a room, inside a ventilation duct and/or inside a building, using ozone.

The air decontamination system of the present invention generally comprises an access chamber having at least one inlet and at least one outlet. The inlet allow contaminated ambient air to enter inside the access chamber where it will be mixed with ozone while the outlet allows the air/ozone mix to leave the access chamber in order to flow through the treatment chamber or chambers.

In order to maintain a relatively constant circulation of air through the system, the latter is equipped with at least one air propulsion means, generally embodied as a fan or blower. The fan is generally installed either at the inlet or at the outlet of the access chamber. Still, if necessary, the present system could be provided with a first fan at the inlet and a second fan at the outlet. Other embodiments are also possible.

In addition, the system also comprises at least one ozone generator. The ozone generator can be installed either inside or outside the access chamber. Preferably, the ozone generator is installed inside the access chamber or directly at the outlet thereof in order to be able to generate ozone directly from the oxygen contained in the ambient air and to directly mix the ozone so generated with the ambient air to be treated. If the ozone generator is installed outside the access chamber, it must be in fluid communication therewith in order for the ozone to be mixed with the ambient air circulating inside the access chamber. Still, it is important to note that the final configuration of the system will at least partially depend on the position of the ozone generator with respect to the other elements of the system. Several configurations are thus possible.

Finally, the system comprises at least one treatment chamber which is in fluid communication with the outlet of the access chamber and which receives the air/ozone mix. In this respect, the system can advantageously treat such a portion of the ambient air with higher concentrations of ozone (e.g. in the order of 20 ppm or higher), resulting in an improved decontamination. This is possible since the contaminated ambient air and ozone mix is not directly returned to the room at the outlet of the ozone generator. Accordingly, the action of the ozone is more effective since concentrated on the limited amount of ambient air circulating in the treatment chamber. Typically, the treatment chamber is a flexible conduit which can be more or less long.

In accordance with one aspect of the present invention, the conduit forming the treatment chamber is sized in diameter and/or in length to provide enough time for the ozone to decontaminate the ambient air of the air/ozone mix during the passage thereof in the conduit.

In accordance with another aspect of the present invention, when the ozone generator is located inside the access chamber or between the access chamber and the treatment chamber, the system can advantageously be provided with flow control means. These flow control means are generally used to slow down the flow of ambient air inside the system in order to increase the contact time between the oxygen contained in the ambient air and the ozone generator. Depending on the actual position of the ozone generator, these flow control means could be installed at different locations along the system. For instance, they could be installed at the inlet of the access chamber, at the outlet of the access chamber, at the outlet of the ozone generator or at the outlet of the treatment chamber; the present invention is understandably not so limited.

Depending on the complexity of the system, the flow control means could vary from a simple opening having a predetermined size to a more complex control valve. Several embodiments are thus possible.

In certain embodiments, the system could be programmable and/or remotely controllable via a remote control or via a central management system connected thereto via a communication network. Hence, the air decontamination system could be programmed to automatically activate itself when the level of one or more contaminants reaches a predetermined threshold. Also, several air decontamination systems could be installed in a building and connected to a central management system via a communication network. It would then be possible to individually control each system.

In accordance with yet another aspect of the present invention, the air contamination is typically permanently installed inside the room of a building. More particularly, the system is preferably, but not exclusively, installed in the ceiling space of the room. According to this preferred configuration, the system picks up and cleans a portion of the contaminated ambient air which circulates in the ceiling space and which generally flows toward one of the collecting ducts of the building's ventilation system. The system then returns the decontaminated ambient air to the untreated ambient air in order for them to be collected by the collecting duct. By being mixed in the flow of contaminated ambient air, the residual ozone present in the decontaminated ambient air is further diluted.

Alternatively, the air decontamination system could be installed directly inside or in parallel of a return duct connected to one of the collecting ducts of the building's ventilation system. Other configurations are also possible; the installation of the present invention is not limited to one particular configuration or one particular location.

The features of the present invention which are believed to be novel are set forth with particularity in the appended claims.

### BRIEF DESCRIPTION OF THE DRAWINGS

The above and other objects, features and advantages of the invention will become more readily apparent from the following description, reference being made to the accompanying drawings in which:

FIG. 1 is a schematic view of the air decontamination system according to a preferred embodiment.

FIG. 2 is a fragmentary view of the outlet of the ozone generator and of an embodiment of the flow-controlling means of FIG. 1.

FIG. 3 is a fragmentary view of the outlet of the ozone generator and of another embodiment of the flow-controlling means of FIG. 1.

FIG. 4 is a schematic view of the air decontamination system of FIG. 1 as installed in the ceiling space of a room.

FIG. 5 is a schematic view of the air decontamination system of FIG. 1 as installed inside a return duct.

FIG. 6 is a schematic view of the air decontamination system of FIG. 1 as installed in parallel of a return duct.

### DETAILED DESCRIPTION OF THE PREFERRED EMBODIMENT

A novel air decontamination system will be described hereinafter. Although the invention is described in terms of specific illustrative embodiments, it is to be understood that the embodiments described herein are by way of example only and that the scope of the invention is not intended to be limited thereby.

Essentially, the air decontamination system of the present invention uses ozone, preferably generated from the oxygen of the ambient air, in order to decontaminate the latter. Additionally, the system is configured so that the residual ozone remaining in the decontaminated ambient air can be easily mixed and diluted in untreated ambient air in order to render it harmless to higher life forms such as humans and animals.

Typically, the air decontamination system 1 of the present invention is configured to be used in cooperation with the ventilation system of a building. Generally, the system 1 comprises an access chamber 3 adapted to received the ambient air 31 to be decontaminated, one or more ozone generators 11 adapted to generate the ozone used for decontaminating the ambient air 31 and one or more treatment chambers 19 adapted to receive the air/ozone mix.

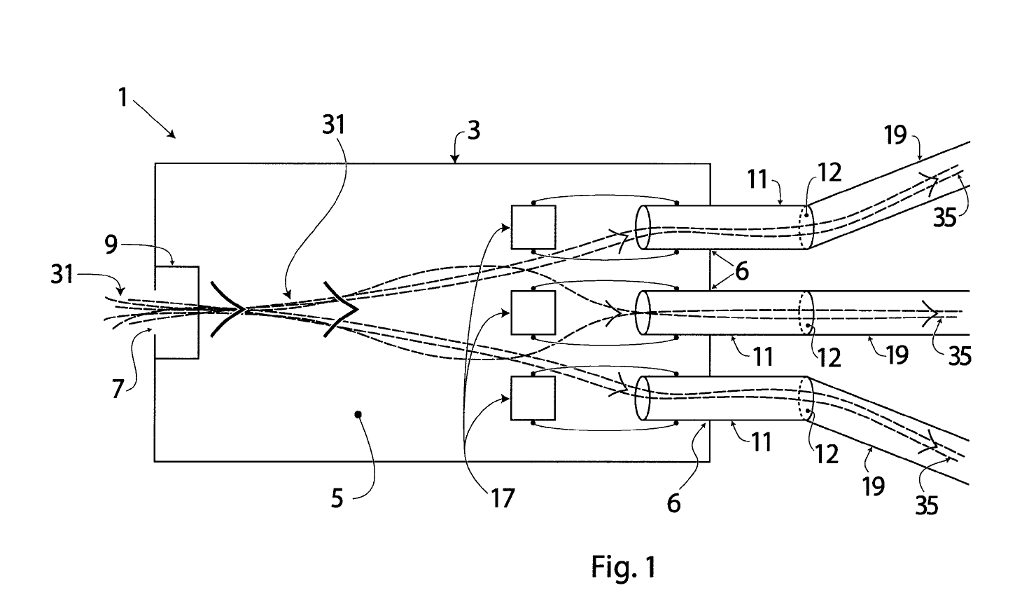

More particularly and referring to FIG. 1, the access chamber 3 of the system 1 generally defines an inner space 5 and comprises at least one inlet 7 and at least one outlet 6. The inlet 7, which is generally an opening, is generally adapted to allow ambient air 31 to enter inside the access chamber 3, whereas the outlet 6, which is also generally an opening, is generally adapted to allow the air/ozone mix 35 to exit the access chamber 3. Understandably, the access chamber 3 could comprise more than one inlet 7 and/or more than one outlet 6. For instance, in the embodiment of FIG. 1, the access chamber 3 comprises a single inlet 7 but three outlets 6. Additionally, the location and configuration of the inlet 7 and outlet 6 can vary depending on the actual shape of the access chamber 3.

For the remainder of the present description, the singular form shall be used to describe structures and elements which can be single or multiple (e.g. inlet 7, outlet 6, ozone generator 11, etc.). The plural form shall however be used when necessary for a better understanding of the present invention.

Still referring to FIG. 1, the air decontamination system 1 also comprises at least one air propulsion means, generally embodied as an electric fan or a blower 9. In the embodiment shown in FIG. 1, the fan 9 is mounted at the inlet 7 of the access chamber 3. Still, since the objective of the fan 9 is to provide a relatively constant flow of air through the system 1, the fan 9 could alternatively be mounted at the outlet 6 or even elsewhere along the system 1; the present invention is not so limited. In addition, more than one fan 9 could be used. For example, one fan 9 could be mounted at the inlet 7 while another fan 9 could be mounted at the outlet 6. Hence, the configuration shown in FIG. 1 is by no means limitative in nature.

Preferably, the fan 9 is controllable in order to be able to control the flow of air circulating through the system 1. Regarding the capacity of the fan 9, generally measured in cubic feet per minute (CFM), it shall generally be proportional to the size and configuration of the system 1. The skilled addressee shall be able to determine the capacity of the fan 9 for a particular system 1.

In order to be able to effectively decontaminate the ambient air 31, the system 1 further comprises at least one ozone generator 11. Preferably, and as shown in FIG. 1, the ozone generator 11 is directly mounted inside the access chamber 3. So mounted, the ozone generator 11 can generate ozone directly from the oxygen contained in the ambient air 31 and directly mix the ozone so generated with the ambient air 31 wherein the ozone will neutralize and destroy airborne contaminants.

As for the fan 9, the ozone generator 11 is preferably controllable in order to be able to control the quantity of ozone generated thereby. Also, and as for the fan 9, the capacity of the ozone generator 11 will be determined based on the size and configuration of the system 1 and by the level of contaminants in the ambient air 31. The skilled addressee shall be able to determine the capacity of the ozone generator 11 for a particular system 1.

In certain embodiments of the system 1 such as the one shown in FIG. 1, the system 1 can comprise several ozone generators 11 if necessary or found to be advantageous. These ozone generators 11 can preferably be individually turned on or off depending on the level of contaminants in the ambient air 31 to be treated. Additionally, each ozone generator 11 could be associated with one of the outlets 6 of the access chamber 3 as shown in the embodiment of FIG. 1. Still, other embodiments are also possible.

Advantageously, in order to increase the concentration of ozone in the air/ozone mix 35 and/or in order to increase the efficiency of the ozone generator 11, the system 1 could be provided with flow control means adapted to slow the flow of ambient air 31 in the vicinity of the ozone generator 11. By slowing the flow of ambient air 31 near the ozone generator 11, the contact time between the oxygen present in the ambient air 31 and the ozone generator 11 is increased, thus increasing the quantity of ozone generated thereby.

Depending on the exact position of the ozone generator 11, the flow control means could be disposed at several locations along the system 1. For example, the flow control means could be disposed at the inlet 7 of the access chamber 3, at the outlet 6 of the access chamber 3 and/or at the outlet 12 of the ozone generator 11. In the preferred embodiment shown in FIG. 1, the flow control means are installed at the outlet 12 of the ozone generator 11.

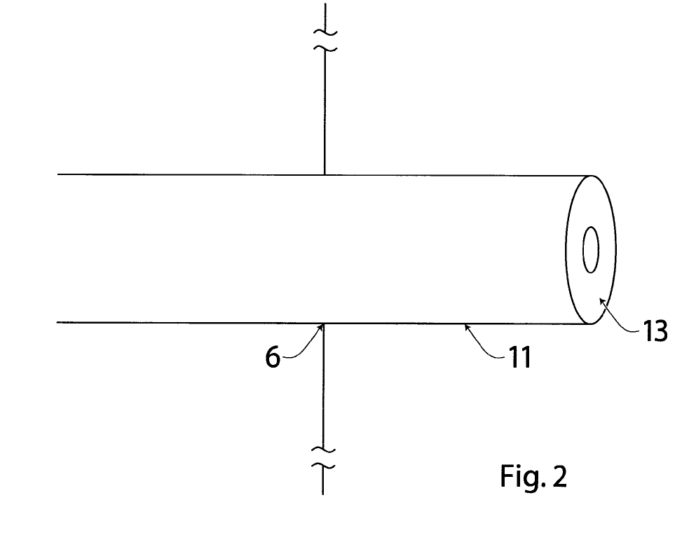

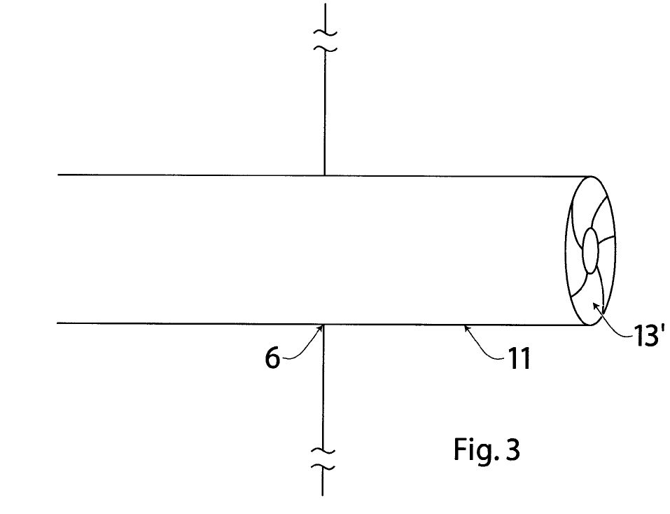

FIGS. 2 and 3 show two exemplary embodiments of the flow control means. In FIG. 2, the flow control means 13 are embodied as a perforated plate mounted at the outlet 12 of the ozone generator 11 and defining at least one opening having a predetermined size. In FIG. 3, the flow control means 13′ are embodied as a variable-rate controllable valve mounted at the outlet 12 of the ozone generator 11. Other means are however possible.

It is to be noted that since the main objective of the flow control means is to increase and/or control the contact time between the ambient air 31 and the ozone generator 11, the position of the flow control means will generally depend on the position of the ozone generator 11. Hence, several configurations are possible.

Moreover, depending on the type of ozone generator 11 used in the system 1, the skilled addressee may have to modify and/or adjust one or more elements thereof.

Accordingly, in certain embodiments, if the ozone generator 11 is a tube or a conduit into which an electrode is disposed and through which the ambient air 31 can flow, then the ozone generator 11 could be placed at the outlet 6 of the access chamber 3 instead of being installed inside. In this case, and as mentioned above, the flow control means could be mounted at the outlet 12 of the ozone generator. It is also possible to conceive an embodiment where the access chamber 3 and the ozone generator 11 are unitary and form essentially a single structure.

Also, should the ozone generator 11 be located outside the access chamber 3, it would be possible to conceive another embodiment where the access chamber 3 and the treatment chamber 19 are unitary and form essentially a single structure.

Returning to FIG. 1, the air decontamination system 1 of the present invention also comprises at least one electrical power supplies 17 adapted to supply the ozone generator 11 with electricity. Though not shown, the system 1 generally also comprises at least another electrical power supply adapted to supply the fan or fans 9 with electrical power. Still, the system 1 could comprise a single electrical power supply for all the electrically-powered elements thereof; the present invention is not so limited.

In order to control the system 1, all the controllable elements such as the fan 9 and the ozone generator 11 are preferably connected to control means (not shown). Depending on the level of automation of the system 1, the control means can vary from simple devices such slide or push-button dimmers to more advance devices such as micro-controllers, programmable automatons or a central console. The more advance devices could further be connected to a central management system via a communication network. Understandably, depending on the intended use of the system 1, different control means could be used; the present invention is not so limited.

Advantageously, the air decontamination system 1 of the present invention can treat ambient air 31 with high concentration of the ozone. Even though the minimal concentration of ozone needed to have a decontaminating effect is usually 3 ppm, in the preferred embodiment herein described, the concentration of ozone in the air/ozone mix 35 is preferably higher than 10 ppm, most preferably higher than 15 ppm and ultimately preferably higher than 20 ppm. Nevertheless, depending on the level of contamination of the ambient air 31, higher or lower concentrations of ozone could be used.

In order to prevent the air/ozone mix 35 from returning directly into the ambient air, each access chamber outlet 6 or each ozone generator outlet 12 is preferably connected to a treatment chamber 19. The treatment chamber 19 essentially serves two purposes. Firstly, by preventing the dilution of the air/ozone mix 35 with ambient air, the concentration of ozone in the mix 35 remains high, thereby having a more potent decontamination effect. Secondly, the treatment chamber 19 provides time during which the ozone can neutralize and/or destroy the contaminants and be destroyed at the same time. Hence, at the outlet of the treatment chamber 19, the concentration of ozone in the air/ozone mix 35 is reduced and thus less harmful.

Preferably, but not exclusively, the treatment chamber 19 is a flexible conduit having a fixed length. In the preferred embodiment of the present invention, the length of the treatment chamber 19 is approximately 20 meters. Still, other lengths could be used.

Still, the length of the treatment chamber 19 could possibly be adjustable. For example, the treatment chamber 19 could be a telescopic tube or conduit or could be comprised of several pipes connectable together. The system 1 could also be provided with several removable treatment chambers 19 having different lengths, each of which adapted to a particular concentration of ozone. Other embodiments are also possible.

Even though not shown in FIG. 1, the air decontamination system 1 of the present invention could be advantageously equipped with all the necessary sensors. For example, the system 1 could comprise sensors for measuring the level of one or more contaminants in the ambient air, for measuring the concentration of ozone at the outlet 12 of the ozone generator 11 and/or for measuring the concentration of ozone at the outlet of the treatment chamber 19. Connected to programmable control means, these sensors would allow the system 1 to adequately dose the required concentration of ozone for a given level of contaminants.

In accordance with the present invention, the air decontamination system 1 is generally used in cooperation with the ventilation system of the building into which the system 1 is installed.

Typically, the ventilation system of a building comprises a central treatment system (not shown) which receives the ambient air collected from each room or area of the building, treats a portion of the collected ambient air (i.e. filtration, humidification or dehumidification, cooling or heating, etc.) and expels the rest outside the building, mixes the treated air with fresh air taken from outside the building and distributes the treated air and fresh air mix to each room or area via ventilation ducts.

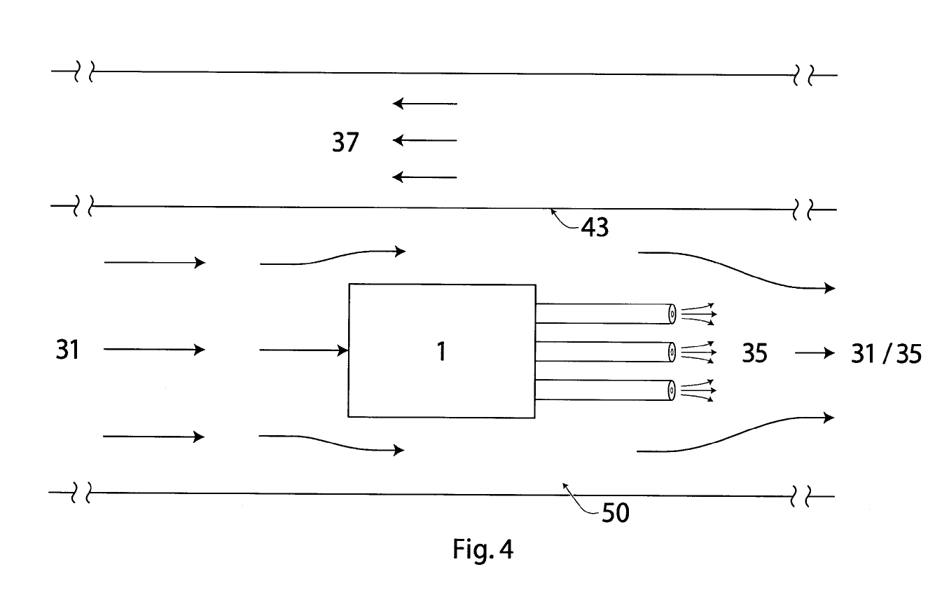

Referring now to FIG. 4, the air decontamination system 1 of the present invention is shown installed in the ceiling space 50 of a room. Indeed, the ceiling space 50 of a room is commonly use as a return duct for collecting the ambient air 31 of a room which is returning to the central treatment system for reprocessing via a collecting duct (not shown).

By being placed in the ceiling space 50, the system 1 picks up a portion of the ambient air 31 returning to the central treatment system and treats it with a high concentration of ozone in order to neutralize and/or destroy most of the contaminants. At the exit of the system 1, the air/ozone mix 35 is returned to and mixed with the untreated portion of the ambient air 31 which is flowing toward the collecting duct.

Since the air/ozone mix 35 is not directly returned in a room where humans and/or animals could be, the residual ozone of the air/ozone mix 35 will not affect these humans or animals.

Moreover, by being mixed with the untreated portion of the ambient air 31 returning to the central treatment system, the air/ozone mix 35 will be diluted in this untreated portion of the ambient air 31 and the residual ozone will have additional time to neutralize and/or destroy contaminants, to be diluted and/or to revert back to oxygen.

Hence, when the untreated ambient air 31 and the air/ozone mix 35 will have been collected, processed by the central treatment system, mixed with fresh air and redistributed to each room via ventilation ducts 43 as clean air 37, the concentration of ozone still remaining in the clean air 37 will preferably be in the order of 0.01 ppm and at the very least, below the Canadian safety standard (i.e. <0.05 ppm), the American safety standard (i.e. <0.08 ppm) and the general international safety standard (i.e. <0.1 ppm).

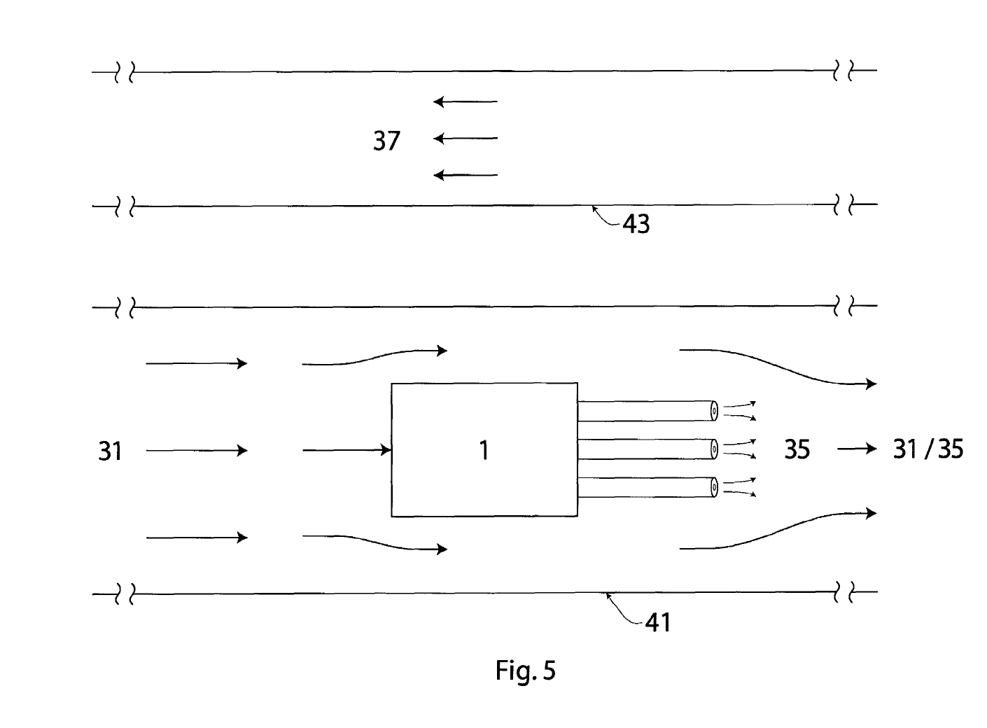

A first variant of the installation shown in FIG. 4 is shown in FIG. 5. In this variant, the air decontamination system 1 is directly installed inside a return duct 41 through which the ambient air 31 of a room returns to the central treatment system. Still, the functioning of the system 1 remains the same.

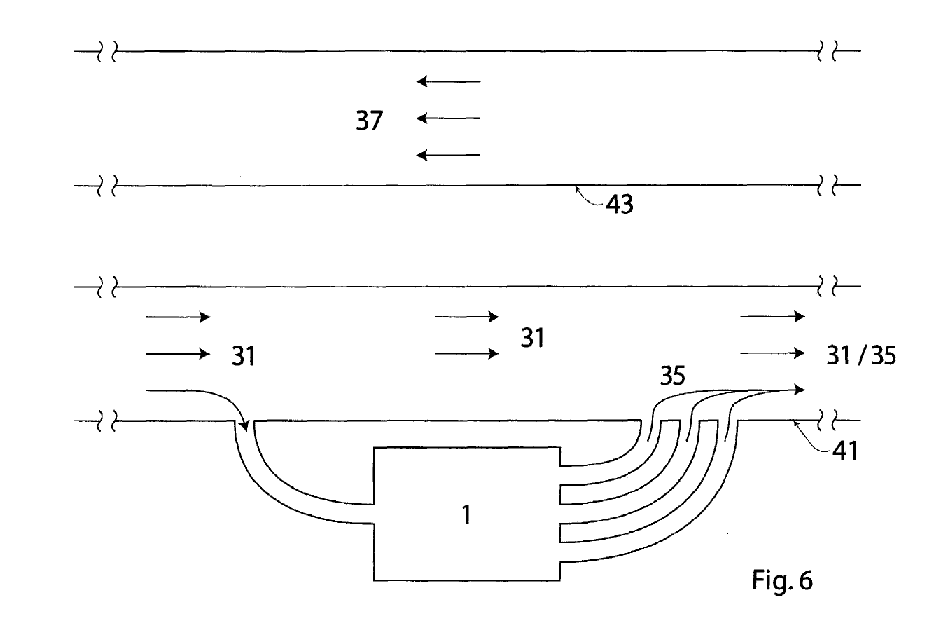

A second variant of the installation shown in FIG. 4 is shown in FIG. 6. In this variant, the air decontamination system 1 is installed in parallel and connected to the return duct 41. Still, the functioning of the system 1 remains the same.

By regularly and continuously decontaminating a portion of the ambient air 31 of a room, all the ambient air of a building ends up being decontaminated by the air decontamination system 1. Understandably, if several systems 1 are installed inside a building, the time required to decontaminate all the ambient air 31 will be correspondingly reduced.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

1. An air decontamination system comprising:
a. an access chamber comprising a first inlet and a first outlet, said access chamber being adapted to receive contaminated ambient air;
b. air propulsion means for propelling said contaminated ambient air through said system;
c. an ozone generator in fluid communication with said access chamber, said ozone generator being adapted to generate ozone and to mix said ozone with said contaminated ambient air;
d. a treatment chamber comprising a second inlet and a second outlet, said second inlet being in fluid communication with said first outlet, said treatment chamber being adapted to receive said mix of contaminated ambient air and ozone;
whereby said ozone substantially decontaminates said contaminated ambient air.

2. A system as claimed in claim 1, wherein said treatment chamber is sized and configured to allow said ozone to decontaminate said contaminated ambient air.

3. (canceled)

4. A system as claimed in claim 1, wherein said ozone generator is controllable.

5. A system as claimed in claim 1, wherein said ozone generator is disposed inside said access chamber.

6. A system as claimed in claim 5, wherein said access chamber further comprises flow control means for controlling the flow of said contaminated ambient air therethrough.

7. A system as claimed in claim 6, wherein said flow control means are a perforated plate having at least one opening.

8. A system as claimed in claim 6, wherein said flow control means are a variable-speed motor.

9. (canceled)

10. (canceled)

11. A system as claimed in claim 1, wherein said ozone generator comprises a third inlet and a third outlet and wherein said ozone generator is substantially mounted between said first outlet and said second inlet.

12. A system as claimed in claim 11, wherein said ozone generator further comprises flow control means for controlling the flow of said contaminated ambient air therethrough, said flow control means being mounted at the third outlet.

13. A system as claimed in claim 12, wherein said flow control means are a perforated plate having at least one opening.

14. (canceled)

15. (canceled)

16. A system as claimed in claim 1, wherein said treatment chamber is a conduit.

17. A system as claimed in claim 16, wherein said conduit is flexible.

18. A system as claimed in claim 1, wherein the concentration of said ozone in said contaminated ambient air and ozone mix is equal or greater than 3 ppm.

19. A system as claimed in claim 1, wherein the concentration of said ozone in said contaminated ambient air and ozone mix is equal or greater than 10 ppm.

20. (canceled)

21. A system as claimed in claim 1, wherein the concentration of said ozone in said contaminated ambient air and ozone mix is equal or greater than 20 ppm.

22. A system as claimed in claim 1, wherein said access chamber and said treatment chamber are unitary.

23. A system as claimed in claim 1, wherein said system is installed in a ceiling space of a room of a building.

24. A system as claimed in claim 1, wherein said system is installed in a ventilation duct of a ventilation system of a building.

25. (canceled)

26. A system as claimed in claim 1, wherein said system is installed in parallel of and is connected to a return duct of a ventilation system of a building.
